(19) United States
(12) Patent Application Publication
(10) Pub. No.: US 2014/0367323 A1
(43) Pub. Date: Dec. 18, 2014

(54) DURABLE FEATHER OIL ABSORBENT FELT, METHOD FOR FABRICATING OIL SORBENT BOOM, AND OIL SORBENT BOOM STRUCTURE

(71) Applicant: Zhenhuang Yu, Shanghai (CN)

(72) Inventor: Zhenhuang Yu, Shanghai (CN)

(21) Appl. No.: 14/379,750

(22) PCT Filed: Mar. 27, 2012
(86) PCT No.: PCT/CN2012/073113

§ 371 Date: Aug. 20, 2014

(51) Int. Cl. E02B 15/06; B65B 1/02; C09K 3/32; C02F 1/28

(52) U.S. Cl. CPC E02B 15/06; C02F 1/286; B65B 1/02; C09K 3/32; C02F 2101/32
USPC 210/242.4; 53/452; 502/401

(57) ABSTRACT

A method for preparing durable feather oil absorbent felt comprising the following steps: water repelling treatment; rolling and pressing by a roller, and drying and baking operation Also provided is a method for preparing a durable oil absorbent boom comprising: (a) using polyester spun-bonded nonwoven cloth, polyester/polyethylene bi-component spun-bonded nonwoven cloth or vinylon fiber and acrylic ester chemically bonded nonwoven cloth as a raw material to make a cloth bag through ultrasonic bonding or thread sewing; the density of the nonwoven cloth ranges from 10 g/m² to 25 g/m²; (b) filling feather oil absorbent felt into the cloth bag, and sealing the two ends of the bag. Also provided is a durable feather oil absorbent boom structure comprising: a cloth bag and feather oil absorbent felt filled into the cloth bag, and the cloth bag is sealed at its two ends.

### BACKGROUND OF THE INVENTION

The present invention relates to a kind of oil absorbent boom, and more specifically relates to a durable feather oil absorbent boom structure prepared from feathers and a preparation method therefor. The present invention relates to the field of environmental protection.

In harbor ports where oil tankers visit frequently, small amount of crude oil spill will occur and thus causing water pollution when the oil tankers load and unload crude oil. Therefore, oil absorbent booms are often provided in advance on the water surrounding the oil tankers for preventing the oil from spreading and for absorbing the spilled oil.

In most situations, only a very small amount of oil will be spilled every time an oil tanker loads and unloads oil. In order to increase the efficiency of using the oil absorbent booms so as to reduce the works required every time to set up the oil absorbent booms, a set of oil absorbent booms set up in a harbor port will be used consecutively for 15 days or more before replacement. At present, there are mainly two types of oil absorbent boom: polypropylene meltblown felt and feather oil absorbent felt.

A polypropylene meltblown felt is made by polypropylene meltblown felt and thermally fused polypropylene nonwoven cloth bag. Polypropylene material is very poor at resisting ultraviolet radiation, and its strength will reduce drastically after direct exposure to sunlight for consecutive number of days. Since the polypropylene meltblown felt is not strong enough, it will further degrade under the effect of ultraviolet and will be easily damaged when coupled with the effect of wind and waves on the sea. Therefore, the polypropylene meltblown felt cannot be used for a long period of time.

Feather oil absorbent felt is made by thermal fusion of feathers and bicompound fibers of polypropylene/polyethylene having a low melting point. Strength of the feather oil absorbent felt is higher. In the feather oil absorbent felt, the polyethylene being the agent for fusing is good at resisting ultraviolet degradation. However, the fused material also contains polypropylene whose strength will reduce drastically after exposure to sunlight for a consecutive number of days, and thus affecting the overall strength of the feather oil absorbent felt. Furthermore, feathers in the feather oil absorbent felt can absorb water because they are being rinsed and degreased. Although the water absorption rate of feathers is slow, feathers may still be saturated with water if they are floating on water for tens of days consecutively. Also, since feathers are denser than water, the feather oil absorbent felt may sink into the water and lose its buoyancy for containing pollutants when it is saturated with water. When feather oil absorbent felt and spunbonded-meltblown-spunbonded polypropylene compound nonwoven cloth bag are used together, in other words, when the feather oil absorbent felt is filled into the spunbonded-meltblown-spunbonded polypropylene compound nonwoven cloth bag, water can be prevented from entering the feather oil absorbent felt through the cloth bag. However, there are still two problems: The first problem is that polypropylene material is poor at resisting ultraviolet degradation and its strength reduces drastically after exposure to direct sunlight for tens of days consecutively; the second problem is that spunbonded-meltblown-spunbonded polypropylene compound structure has limited tolerance against water pressure; in normal situation where water pressure does not exceed 300 mmH₂O, water blockage can be ensured. However, it is highly possible to experience waves with water pressure exceeding 300 mmH₂O when floating on the sea for tens of days consecutively; therefore, it is possible for water to get through the cloth bag and reach the feather oil absorbent felt, causing a decrease in buoyancy of the oil absorbent boom. Accordingly, the two types of oil absorbent boom are still not durable and reliable enough when they are required to float on the sea consecutively for more than half a month.

### BRIEF SUMMARY OF THE INVENTION

In view of the aforesaid disadvantages now present in the prior arts, the present invention provides a method of preparing a durable feather oil absorbent felt.

Another object of the present invention is to provide a method of preparing a durable feather oil absorbent boom.

Still another object of the present invention is to provide a durable feather oil absorbent boom structure. The feather oil absorbent boom structure of the present invention can float on the sea for a long period of time (at least 15 days) for containing spilled oil and for absorbing oil.

The present invention has the following technical features:

A method of preparing a durable feather oil absorbent felt comprises the following steps:

a) Water repelling treatment: soak the feather oil absorbent felt into a water repellent reagent or spray the water repellent reagent into the feather oil absorbent felt by means of double-sided spray for water repellent treatment. The feather oil absorbent felt is formed by thermal fusion of feathers and bicomponent fibers of polypropylene/polyethylene having a low melting point. Weight ratio of the feathers to the bicomponent fibers of polypropylene/polyethylene having a low melting point is 70-85:15-30. The feather oil absorbent felt has an average surface density of 150 g/m²-400 g/m².

b) Rolling and pressing by a roller: roll and press the feather oil absorbent felt after water repelling treatment by using a roller so that a liquid rate is obtained according to which weight of the water repellent reagent is 5-10% of the weight of the feather oil absorbent felt after drying.

c) Drying and baking operation: put the feather oil absorbent felt after rolling and pressing into a drying oven for drying under 120° C.-135° C., and then bake the feather oil absorbent felt under 145° C.-150° C. to obtain the water repellent and oil absorbent feather oil absorbent felt.

Further, the water repellent reagent is paraffin-aluminum soap emulsion, fatty acid chromium complex solution or organic silicon emulsion.

Further, the water repellent reagent is organic silicon emulsion; the organic silicon emulsion is diluted to 3-7% by using water.

A method of preparing a durable feather oil absorbent boom comprises the following steps:

a) Use polyester spunbonded nonwoven cloth or spunbonded nonwoven cloth of polyester/ polyethylene bicomponent or nonwoven cloth of chemically bonded vinylon fiber and acrylic ester as raw material to make a cloth bag by means of bonding by ultrasonic or stitching by sewing threads; the nonwoven cloth has a surface density of 10-25 g/m².

b) fill the water repellent and oil absorbent feather oil absorbent felt into the cloth bag, and then seal two ends of the cloth bag to form the durable feather oil absorbent boom.

A durable feather oil absorbent boom structure prepared by the method of preparing a durable feather oil absorbent boom as described above comprises:

a cloth bag; and

water repellent and oil absorbent feather oil absorbent felt filled into the cloth bag, whereas two ends of the cloth bag are sealed.

The present invention has the following advantages:

1. Polyester spunbonded nonwoven cloth, spunbonded nonwoven cloth of polyester/ polyethylene bicomponent and nonwoven cloth of chemically bonded vinylon fiber and acrylic ester are all good at resisting ultraviolet degradation and therefore can be exposed to direct sunlight for a longer period of time while maintaining the strength of the materials. Therefore, the cloth bag of the oil absorbent boom is able to withstand sunlight radiation without reduction of its strength. Also, use of a cloth bag can prevent sunlight from directly radiating on the water repellent and oil absorbent feather oil absorbent felt in the cloth bag, thereby significantly reducing the effect of ultraviolet radiation on the strength and bonding structure of the oil absorbent felt inside the cloth bag.

2. Inside the cloth bag, the oil absorbent felt formed by feathers and bicomponent fibers of polypropylene/polyethylene having a low melting point is subject to water repellent treatment and so it can absorb oil but will not absorb water. In this case, the oil absorbent felt will not be affected by the waves on the sea, no matter big or small. Although the material making the cloth bag is water permeable, buoyancy of the feather oil absorbent boom is provided by the feather oil absorbent felt in the cloth bag. The cloth bag is provided for strengthening and blocking sunlight from directly radiating onto the feather oil absorbent felt. Therefore, the feather oil absorbent boom can ensure its buoyancy and integrity within a long period of time (at least 15 days) on the sea.

3. The amount of oil absorbable by the feather oil absorbent felt of the present invention is 2-4 times the amount of oil absorbable by polypropylene meltblown oil absorbent felt of the same weight. Since the durable feather oil absorbent boom of the present invention is used as a protective material during a long period of time, its capability to absorb large amount of oil allows it to absorb large amount of oil pollutants even when large scale oil spill occurs during accidents. The present invention is very adaptable to various complicated situations which may happen during a long period of time.

### BRIEF DESCRIPTION OF THE DRAWINGS

FIG. 1 is a sectional view showing a structure of the feather oil absorbent boom according to the present invention.

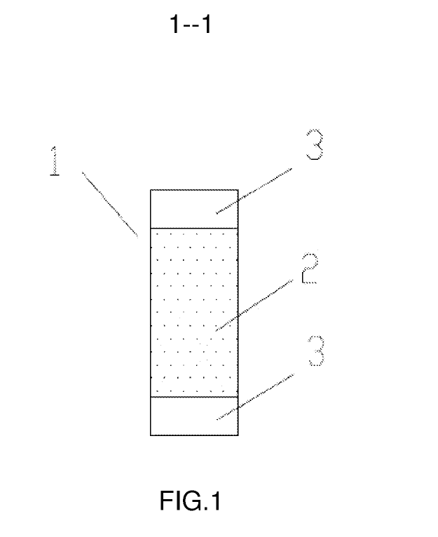

### DETAILED DESCRIPTION OF THE INVENTION

The present invention will be described in detail below with reference to some embodiments. A durable feather oil absorbent boom of the present invention comprises two parts: a cloth bag 1 and a water repellent and oil absorbent feather oil absorbent felt 2 filled into the cloth bag 1. Two ends 3 of the cloth bag 1 are sealed. The feather oil absorbent felt 2 is an oil absorbent felt formed by thermal fusion of feathers and bicomponent fibers of polypropylene/polyethylene having a low melting point. This kind of oil absorbent felt becomes the water repellent and oil absorbent feather oil absorbent felt after 3 steps of processing, namely, water repelling treatment, rolling and pressing by a roller, and drying and baking operation. In the water repellent and oil absorbent feather oil absorbent felt, weight ratio of feathers to polypropylene/polyethylene fibers is 70-85:15-30. The oil absorbent felt has an average surface density of 150 g/m²-400 g/m².

### Embodiment 1

Dilute organic silicon emulsion (containing 30% solid contents) down to 3% by using water to obtain a diluted organic silicon solution; prepare a feather oil absorbent felt by thermal fusion of feathers and bicomponent fibers of polypropylene/polyethylene having a low melting point; weight ratio of the feathers to the bicomponent fibers of polypropylene/polyethylene is 75:25; soak the feather oil absorbent felt having a surface density of 300 g/m² into the diluted organic silicon solution for water repelling treatment, and then roll and press the feather oil absorbent felt after water repelling treatment by using a roller to obtain a liquid rate according to which there are 15 g/m² of organic silicon in the feather oil absorbent felt after drying; after that, put the feather oil absorbent felt into a drying oven for drying under 120° C.-135° C.; the water repellent and oil absorbent feather oil absorbent felt is formed by baking under 145° C.-150° C.

### Embodiment 2

Dilute organic silicon emulsion (containing 30% solid contents) down to 7% by using water to obtain a diluted organic silicon solution; prepare a feather oil absorbent felt by thermal fusion of feathers and bicomponent fibers of polypropylene/polyethylene having a low melting point; weight ratio of the feathers to the bicomponent fibers of polypropylene/polyethylene is 85:15; soak the feather oil absorbent felt having a surface density of 180 g/m² into the diluted organic silicon solution for water repelling treatment, and then roll and press the feather oil absorbent felt after water repelling treatment by using a roller to obtain a liquid rate according to which there are 18 g/m² of organic silicon in the feather oil absorbent felt after drying; after that, put the feather oil absorbent felt into a drying oven for drying under 120° C.-135° C.; the water repellent and oil absorbent feather oil absorbent felt is formed by baking under 145° C.-150° C.

### Embodiment 3

Prepare a feather oil absorbent felt by thermal fusion of feathers and bicomponent fibers of polypropylene/polyethylene having a low melting point; weight ratio of the feathers to the bicomponent fibers of polypropylene/polyethylene is 80:20; soak the feather oil absorbent felt having a surface density of 300 g/m² into paraffin-aluminum soap emulsion for water repelling treatment, and then roll and press the feather oil absorbent felt after water repelling treatment by using a roller to obtain a liquid rate according to which there are 28 g/m² of paraffin-aluminum soap in the feather oil absorbent felt after drying; after that, put the feather oil absorbent felt into a drying oven for drying under 120° C.-135° C.; the water repellent and oil absorbent feather oil absorbent felt is formed by baking under 145° C.-150° C.

### Embodiment 4

Prepare a feather oil absorbent felt by thermal fusion of feathers and bicomponent fibers of polypropylene/polyethylene having a low melting point; weight ratio of the feathers to the bicomponent fibers of polypropylene/polyethylene is 78:22; soak the feather oil absorbent felt having a surface density of 320 g/m² into fatty acid chromium complex solution (prepared as a 30% alcoholic solution and added with hexamethylene tetramine as a buffer reagent) for water repelling treatment, and then roll and press the feather oil absorbent felt after water repelling treatment by using a roller to obtain a liquid rate according to which there are 25 g/m² of fatty acid chromium complexes in the feather oil absorbent felt after drying; after that, put the feather oil absorbent felt into a drying oven for drying under 120° C.-135° C.; the water repellent and oil absorbent feather oil absorbent felt is formed by baking under 145° C.-150° C.

### Embodiment 5

Dilute organic silicon emulsion (containing 30% solid contents) down to 5% by using water to obtain a diluted organic silicon solution; prepare a feather oil absorbent felt by thermal fusion of feathers and bicomponent fibers of polypropylene/polyethylene having a low melting point; weight ratio of the feathers to the bicomponent fibers of polypropylene/polyethylene is 76:24; soak the feather oil absorbent felt having a surface density of 380 g/m² into the diluted organic silicon solution for water repelling treatment, and then roll and press the feather oil absorbent felt after water repelling treatment by using a roller to obtain a liquid rate according to which there are 35 g/m² of organic silicon in the feather oil absorbent felt after drying; after that, put the feather oil absorbent felt into a drying oven for drying under 120° C.-135° C.; the water repellent and oil absorbent feather oil absorbent felt is formed by baking under 145° C.-150° C.

Prepare a cloth bag of 3.3 m long having a diameter of 200 mm by means of ultrasonic, whereas the cloth bag is made by polyester spunbonded nonwoven cloth having a surface density of 25 g/m²; fill 3 kg of the water repellent and oil absorbent feather oil absorbent felt into the cloth bag with a filling length of 3 m, and then seal the openings at two ends of the cloth bag to form a feather oil absorbent boom.

### Embodiment 6

Dilute organic silicon emulsion (containing 30% solid contents) down to 6% by using water to obtain a diluted organic silicon solution; prepare a feather oil absorbent felt by thermal fusion of feathers and bicomponent fibers of polypropylene/polyethylene having a low melting point; weight ratio of the feathers to the bicomponent fibers of polypropylene/polyethylene is 82:18; spray the diluted organic silicon solution by means of double-sided spray into the feather oil absorbent felt having a surface density of 290 g/m² for water repelling treatment, and then roll and press the feather oil absorbent felt after water repelling treatment by using a roller to obtain a liquid rate according to which there are 25 g/m² of organic silicon in the feather oil absorbent felt after drying; after that, put the feather oil absorbent felt into a drying oven for drying under 120° C.-135° C.; the water repellent and oil absorbent feather oil absorbent felt is formed by baking under 145° C.-150° C.

Prepare a cloth bag of 3.3 m long having a diameter of 200 mm by means of sewing threads, whereas the cloth bag is made by spunbonded nonwoven cloth of polyester/polyethylene bicomponent and the spunbonded nonwoven cloth has a surface density of 15 g/m²; fill 2.4 kg of the water repellent and oil absorbent feather oil absorbent felt into the cloth bag with a filling length of 3 m, and then seal the openings at two ends of the cloth bag to form a feather oil absorbent boom.

### Embodiment 7

Prepare a feather oil absorbent felt by thermal fusion of feathers and bicomponent fibers of polypropylene/polyethylene having a low melting point; weight ratio of the feathers to the bicomponent fibers of polypropylene/polyethylene is 83:17; soak the feather oil absorbent felt having a surface density of 200 g/m² into fatty acid chromium complex solution (prepared as a 28% alcoholic solution and added with hexamethylene tetramine as a buffer reagent) for water repelling treatment, and then roll and press the feather oil absorbent felt after water repelling treatment by using a roller to obtain a liquid rate according to which there are 15 g/m² of fatty acid chromium complexes in the feather oil absorbent felt after drying; after that, put the feather oil absorbent felt into a drying oven for drying under 120° C.-135° C.; the water repellent and oil absorbent feather oil absorbent felt is formed by baking under 145° C.-150° C.

Prepare a cloth bag of 3.3 m long having a diameter of 200 mm by means of sewing threads, whereas the cloth bag is made by nonwoven cloth of chemically bonded vinylon fiber and acrylic ester, and the nonwoven cloth has a surface density of 18 g/m²; fill 2.5 kg of the water repellent and oil absorbent feather oil absorbent felt into the cloth bag with a filling length of 3 m, and then seal the openings at two ends of the cloth bag to form a feather oil absorbent boom.

### Embodiment 8

Prepare a feather oil absorbent felt by thermal fusion of feathers and bicomponent fibers of polypropylene/polyethylene having a low melting point; weight ratio of the feathers to the bicomponent fibers of polypropylene/polyethylene is 81:19; soak the feather oil absorbent felt having a surface density of 300 g/m² into paraffin-aluminum soap emulsion for water repelling treatment, and then roll and press the feather oil absorbent felt after water repelling treatment by using a roller to obtain a liquid rate according to which there are 28 g/m² of paraffin-aluminum soap in the feather oil absorbent felt after drying; after that, put the feather oil absorbent felt into a drying oven for drying under 120° C.-135° C.; the water repellent and oil absorbent feather oil absorbent felt is formed by baking under 145° C.-150° C.

Prepare a cloth bag of 3.3 m long having a diameter of 200 mm by means of sewing threads, whereas the cloth bag is made by nonwoven cloth of chemically bonded vinylon fiber and acrylic ester, and the nonwoven cloth has a surface density of 20 g/m²; fill 2.8 kg of the water repellent and oil absorbent feather oil absorbent felt into the cloth bag with a filling length of 3 m, and then seal the openings at two ends of the cloth bag to form a feather oil absorbent boom.

A person skilled in this field of art should understand that the embodiments described above are examples only. The embodiments are described so that the present invention can be better understood. The embodiments are not intended to limit the scope of protection of the present invention. Any changes and modification made in accordance with the spirit of the present invention should also fall within the scope of protection of the present invention.

1. A method of preparing a durable feather oil absorbent felt, wherein the method comprises the following steps:
a) water repelling treatment: soak a feather oil absorbent felt into a water repellent reagent or spray the water repellent reagent into the feather oil absorbent felt by means of double-sided spray for water repellent treatment, whereas the feather oil absorbent felt is formed by thermal fusion of feathers and bicomponent fibers of polypropylene/polyethylene having a low melting point, whereas a weight ratio of the feathers to the bicomponent fibers of polypropylene/polyethylene having a low melting point is 70-85:15-30, and whereas the feather oil absorbent felt has an average surface density of 150 g/m²-400 g/m²;
b) rolling and pressing by a roller: roll and press the feather oil absorbent felt after water repelling treatment by using a roller so as to obtain a liquid rate according to which weight of the water repellent reagent is 5-10% of weight of the feather oil absorbent felt after drying;
c) drying and baking operation: put the feather oil absorbent felt after rolling and pressing into a drying oven for drying under 120° C.-135° C., and then bake the feather oil absorbent felt under 145° C.-150° C. to obtain a water repellent and oil absorbent feather oil absorbent felt.

2. The method of preparing a durable feather oil absorbent felt as in claim 1, wherein the water repellent reagent is paraffin-aluminum soap emulsion, fatty acid chromium complex solution or organic silicon emulsion.

3. The method of preparing a durable feather oil absorbent felt as in claim 2, wherein the water repellent reagent is the organic silicon emulsion; the organic silicon emulsion is diluted to 3-7% by using water.

4. A method of preparing a durable feather oil absorbent boom, wherein the method comprises the following steps:
a) use polyester spunbonded nonwoven cloth or spunbonded nonwoven cloth of polyester/polyethylene bicomponent or nonwoven cloth of chemically bonded vinylon fiber and acrylic ester as raw material to make a cloth bag via bonding by ultrasonic or stitching by sewing threads; the nonwoven cloth has a surface density of 10-25 g/m².
b) fill durable feather oil absorbent felt into the cloth bag, and then seal two ends of the cloth bag to form the durable feather oil absorbent boom.

5. A durable feather oil absorbent boom structure prepared by the method according to claim 4, wherein the durable feather oil absorbent boom structure comprises:
a cloth bag; and
water repellent and oil absorbent feather oil absorbent felt filled into the cloth bag, whereas two ends of the cloth bag are sealed.
